(19) United States
(12) Patent Application Publication
(10) Pub. No.: US 2016/0016799 A1
(43) Pub. Date: Jan. 21, 2016

(54) METHOD FOR REMOVING METAL IONS IN PHOSPHORIC ACID SOLUTION

(71) Applicant: OCI COMPANY LTD., Seoul (KR)

(72) Inventors: Seung-Hyun HAN, Seongnam-si (KR); Wook CHANG, Seongnam-si (KR)

(21) Appl. No.: 14/800,709

(22) Filed: Jul. 16, 2015

(30) Foreign Application Priority Data
Jul. 18, 2014 (KR) 10-2014-0091303

(51) Int. Cl. C01B 25/238; B01J 39/04

(52) U.S. Cl. CPC C01B 25/238; B01J 39/043

(57) ABSTRACT

The present invention relates to a method for removing metal ions in the phosphoric acid solution, and particularly to a method for removing metal ions in the phosphoric acid solution which comprises a step of passing an ion exchange resin through the acid solution to activate the ion exchange resin; a step of filling a resin tower with the activated ion exchange resin and washing it with ultra-pure water, and a step of passing the phosphoric acid solution to the washed ion exchange resin, thereby causing each individual concentration of metal ions with the oxidation number of 2 to 7 in the phosphoric acid solution to be less than 100 ppb.

### CROSS REFERENCE TO RELATED APPLICATION

This application claims the benefit of Korean Patent Application No. 10-2014-0091303, filed on Jul. 18, 2014, entitled “METHOD FOR REMOVING METAL IONS IN PHOSPHORIC ACID SOLUTION”, which is hereby incorporated by reference in its entirety into this application.

### TECHNICAL FIELD

The present invention relates to a method for removing metal ions in a phosphoric acid solution. In particular, the present invention relates to a method for removing metal ions in the phosphoric acid solution which comprises a step of passing an ion exchange resin through the acid solution to activate the ion exchange resin; a step of filling a resin tower with the activated ion exchange resin and washing it with ultra-pure water, and a step of passing the phosphoric acid solution to the washed ion exchange resin, thereby causing each individual concentration of metal ions with an oxidation number of 2 to 7 in the phosphoric acid solution to be less than 100 ppb.

### BACKGROUND ART

Phosphoric acid is used to remove silicon nitride layer deposited on a semiconductor wafer or to etch metal wiring of displays such as TFT-LCD. In semiconductors, the phosphoric acid is mainly used in the form of pure phosphoric acid mixed with additives. In TFT-LCD, the phosphoric acid is mainly used in the form of mixing additives with a mixed acid obtained by mixing a variety of acids such as phosphoric acid, nitric acid, and acetic acid.

To date, various techniques for reproducing or neutralizing the waste acid used in the above-described removal or etching processes have been developed.

Typically, Korean Patent Application Laid-open Nos. 10-2007-0126299 and 10-2009-0011926 disclose a method for separating phosphoric acid and the other acid from a mixed acid of phosphoric acid, nitric acid and acetic acid through distillation and then removing impurities of aluminum, molybdenum in phosphoric acid using a dialysis method.

In addition, most of the patent families which discloses a technique for purifying waste acids relate to a method which comprises using, as a starting material, a mixed acid of phosphoric acid, nitric acid and acetic acid containing a high concentration of Al, Mo as impurities, distillating the mixed acid to separate the phosphoric acid and then diluting the phosphoric acid, and purifying phosporic acid using an ion exchange membrane, a nano-filter and the like.

However, the standards for the impurity concentration that can be utilized in the semiconductor process are very strict, as the ppt and ppb levels. The ion exchange membrane and the nano-filter utilize different purification method from the ion exchange resin, and there exists a difference in the performance of the methods for removing impurities. Accordingly, it was not possible to obtain purification at a high level by the conventional method as described above.

Specifically, in the case of the purification method using the ion exchange resin, ions are exchanged and purified while the phosphoric acids which pass through the tube containing the ion exchange resin are in contact with the ion exchange resin. Accordingly, only the impurities of phosphoric acid are removed and there is no change in the concentration of phosphoric acid. However, in the case of the purification method using an ion exchange membrane, phosphoric acid is purified according to the principles of diffusion dialysis between the phases of the material while passing phosphoric acid between the membranes. Accordingly, the concentration of the phosphoric acid can be varied due to the purification.

Meanwhile, if yellow phosphorus(P4) itself, raw materials in the production of phosphoric acid, is washed cleanly and then phosphoric acid is produced, it is possible to produce phosphoric acid with a higher purity. Accordingly, techniques of purifying the raw yellow phosphorus have been developed.

Typically, U.S. Pat. No. 5,989,509 discloses a method for removing Sb present in the raw yellow phosphorus, by washing the yellow phosphorus with hydrogen peroxide.

However, there were problems that in the course of purifying the row yellow phosphous, the yield of phosphoric acid is reduced and the process time is increased.

Therefore, there was a need to develop a process for purifying phosphoric acid which solves the problems of the prior arts as described above and which meets the strict levels of impurity purification required for semiconductor processes.

### DISCLOSURE OF INVENTION

### Technical Problem

The present invention was made in consideration of the above described problems, and an object of the present invention is to provide a method for removing metal ions in the phosphoric acid solution which comprises a step of passing an ion exchange resin through the acid solution to activate the ion exchange resin; a step of filling a resin tower with the activated ion exchange resin and washing it with ultra-pure water, and a step of passing the phosphoric acid solution to the washed ion exchange resin, thereby causing each individual concentration of the metal ions with an oxidation number of 2 to 7 in the phosphoric acid solution to be less than 100 ppb.

### Technical Solution to the Problem

In order to accomplish the above object, one embodiment of the present invention provides a method for removing metal ions in the phosphoric acid solution which comprises a step of passing an ion exchange resin through the acid solution to activate the ion exchange resin; a step of filling a resin tower with the activated ion exchange resin and washing it with ultra-pure water, and a step of passing the phosphoric acid solution to the washed ion exchange resin, thereby causing each individual concentration of metal ions with an oxidation number of 2 to 7 in the phosphoric acid solution to be less than 100 ppb.

### Advantageous Effects of the Invention

According to the method of the present invention, each individual concentration of metal ions with the oxidation number of 2 to 7 present in the phosphoric acid solution can be lowered to less than 100 ppb

### DESCRIPTION OF DRAWINGS

FIG. 1 is a schematic view for explaining the step of passing phosphonic acid solution through an ion exchange resin.

### DETAILED DESCRIPTION OF THE INVENTION

Advantages and features of the present invention, and a method for accomplishing the same will become apparent with reference to the embodiments and drawings to be described in detail below. However, the present invention is not intended to be limited to the embodiments and drawings set forth herein, but it is intended to be embodied in many different forms. These embodiments and the drawings are intended to complete the disclosure of the present invention, and they are provided to fully convey the concept of the invention to those skilled in the art to which this invention pertains, however, the present invention is only defined by the appended claims.

Hereinafter, the method for removing metal ions in the phosphoric acid solution in accordance with preferred embodiments of the present invention and the attached drawings will be described in detail.

One embodiment of the present invention provides a method for removing metal ions in the phosphoric acid solution which comprises a step of passing an ion exchange resin through the acid solution to activate the ion exchange resin; a step of filling a resin tower with the activated ion exchange resin and washing it with ultra-pure water, and a step of liquid-passing the phosphoric acid solution to the washed ion exchange resin, thereby causing each individual concentration of metal ions with an oxidation number of 2 to 7 in the phosphoric acid solution to be less than 100 ppb.

First, the step of passing an ion exchange resin through the acid solution to activate the ion exchange resin is described.

Ion-exchange resins used in the present invention can be selected from the group consisting of a strong acidic cation exchange resin, a weak acidic cation exchange resin, a strong basic anion exchange resin, and a weak basic anion exchange resins in consideration of the overall characteristics of the substances to be used, such as strong acids, strong bases, weak acids and the like. The functional groups and terminal groups are determined depending on the oxidation number of the metal ions to be removed.

The present invention is intended to remove metal ions in the phosphoric acid solution and thus, it is preferable to select a strongly acidic cation exchange resin which can be used in a strong acidic phosphoric acid.

Specifically, the ion exchange resin used in the present invention may be cation exchange resins containing any one main chain selected from polystyrens, polyacrylics and divinyl benzenes. In particular, the above-described ion exchange resins may be cation exchange resins, containing any one main chain selected from polystyrens, polyacrylics and divinyl benzenes, including sulfonic acid functional groups, and containing a terminal group including sodium ions or hydrogen ions.

In addition, the ion exchange resin used in the present invention may be a chelate resin having any one main chain selected from polystyrenes, polyacrylics and divinyl benzenes. In particular, the above chelate resin may contain any one main chain selected from polystyrenes, polyacrylics and divinyl benzenes, contain any one functional group selected from the group consisting of glutamine, amidoxime, thiol, amino diacetate, aminophosphone, phosphone/sulfone, picolinic amine and polyamine, and include a terminal group including any one selected from free bases, hydrogen ions, sodium ions, and sulfate ions.

As typical ion exchange resins corresponding to this, a cation exchange resin including C100, C150, C160, C104, C106 and the like (Purolite, Inc.), a nuclear grade strongly acidic cation ion exchange resins including, NRW100, NRW160, NRW1000 and the like, and a chelating resin such as S108, S110, S910, S930, S950, S957, S985 and the like, can be exemplified. In the case of Dow company, there are a cation exchange resin such as amberlite FPC, IR, IRN series, Dowex monosphere series, Dowex Marathon series, Amberjet 1000H, and a chelating resin such as Amberlite IRA743, IRC747, IRC748I, Dowex XUS series. As the strong acidic cation exchange resin, NR-40 and NR-50 (Dupont Company) in which fluoride ions are added to the main chain and which have Nafion structure, can be used.

For the ion exchange resins as described above, their performance may be varied depending on the metal ions to be removed. The ion exchange resin has the selectivity of the metal ions, but there exists a selectivity for a certain oxidation number. Metal ion impurities in the strong acid are always not present at the same oxidation number, and can be changed depending on the concentration or pH of the acid. These may have the oxidation number of the metal ions at a certain distribution. Therefore, there is a need to check the oxidation number distribution in the composition of the substance to be purified, by which selection of the ion exchange resin must be made. That is, if the removal of Al is the main purpose, it is necessary to determine the the oxidation number distribution that Al ions can have in the phosphoric acid, Further, if the concentration of phosphoric acid is very low, it can be present in the form of Al(OH)₃. Therefore, only in this case, it is possible to use a weak acidic anion exchange resin. In the high mass percent concentration of phosphoric acids which are mentioned in the present invention, Al ions are present as Al²⁺, Al⁺³, and so it is desirable to use a strong acidic cation exchange resin and a chelate resin. The ion exchange resin wherein the main chain is polystyrene, polyacrylic, divinyl benzene, or copolymer thereof, the functional groups are sulfonic acids, amino diacetates, amino phosphones, phosphons/sulfones, polyamines, and the terminal groups are sodium ions, hydrogen ions and free bases, is preferred. As a specific type, NRW100, IRC747 and the like can be exemplified.

If the removal of Fe is the main purpose, Fe is present as Fe²⁺, Fe³⁺ in a high concentration of phosphoric acid, and thus it is desirable to use a strong acidic cation exchange resin and a chelate resin. The ion exchange resin wherein the main chain is polystyrene, polyacrylic, divinyl benzene, Nafion or copolymer thereof, the functional groups are sulfonic acids, amino diacetates, amino phosphones, phosphons/sulfones, or polyamines, and the terminal groups are sodium ions, hydrogen ions and free bases, is preferred. As a specific type, NRW160, IRC747, S985 and the like can be exemplified.

If the removal of Sb is the main purpose, Sb is present as Sb³⁺, Sb⁵⁺ in a high concentration of phosphoric acid, and so it will have a high oxidation number. At the high oxidation number, the efficiency of a strong acidic cation exchange resin decreases. In this case, the chelating resin is more preferred. The ion exchange resin wherein the main chain is polystyrene, polyacrylic, divinyl benzene, Nafion-based or a copolymer thereof, the functional group is glutamine, amidoxime, amino diacetate, amino phosphone, phosphone/sulfone, polyamine, and the terminal group is free base, hydrogen ion and sodium ion, is preferred. As a specific type, S110, S985, IRC747 and the like can be exemplified.

Meanwhile, the crosslinking degree (polymerization degree) of polystyrene, polyacrylic, divinyl benzene and the like which are a main chain of the ion exchange resin used in the present invention also affects the purification efficiency. If the crosslinking degree is high, it is not easy for various metal ion impurities to come in or escape (input or output). Therefore, there are advantages in that the exchange capacity per volume increases, the volume change is not extreme, and the purification efficiency increases. In contrast, if the crosslinking degree is low, attaching and deattaching to the ion exchange resin easily are repeated and thus a kind of regeneration effect may be exhibited. In the present invention, the ion exchange resin is not disposable, and can be reused through the regeneration and pretreatment. Therefore, if the crosslinking degree of the main chain is too high in view of the lifetime of the ion exchange resin, it is likely to cause a problem in the process of regeneration. Therefore, it is important to select an ion exchange resin that has a crosslinking degree at an appropriate level. The crosslinking degree of the ion exchange resin according to the present invention is ±5%, based on the divinylbenzene 10% called a standard crosslinking degree, that is, 5 to 15% is preferred.

In the present invention, the acid solution for activation of the ion exchange resin may be a hydrochloric acid. In other words, the metal ion impurities present in the ion-exchange resin is washed with hydrochloric acid to thereby activate an ion exchange resin. Hydrochloric acid used herein is 3-10 mass % of a high purity hydrochloric acid solution, wherein the high purity means that the concentration of metal ions is not greater than 10 ppb based on 35 mass % of hydrochloric acid. Preferably, the concentration of the alkali, alkaline earth metal ion is 10 ppb or less, and the concentration of other metal ions is 1 ppb or less. To satisfy the above conditions, the acid solution for regeneration of the ion exchange resin is diluted; specifically, hydrochloric acid having the metal ion concentration of less than 10 ppb based on 35 mass % of hydrochloric acid is diluted in ultra-pure water at a ratio of 1:3.5 to 1:12 of hydrochloric acid to ultra-pure water. If hydrochloric acid exceeds 10 mass %, it may result in damage to the ion exchange resin. Therefore, in order to obtain the purification efficiency in a maximum capacity, it is desirable to dilute and activate at the ratio range described above.

Next, the step of filling a resin tower with the activated ion exchange resin and washing it with ultra-pure water is described.

When the ion exchange resin is activated, it is filled into the resin tower and then washed with ultra-pure water within 24 hours prior to passing phosphoric acid.

In the present invention, the phosphoric acid is purified by utilizing a continuous resin tower. The activated ion exchange resin as described above is filled into the resin tower so as not to cause a flow, and then washed within 24 hours in a upflow direction using using ultra-pure water. In this course, the hydrochloric acid remaining in the ion exchange resin is completely removed. At this time, the linear velocity of the ultra-pure water is desirably 2.7 M/H˜11.8 M/H.

Next, the step of passing the phosphoric acid solution to the washed ion exchange resin is described.

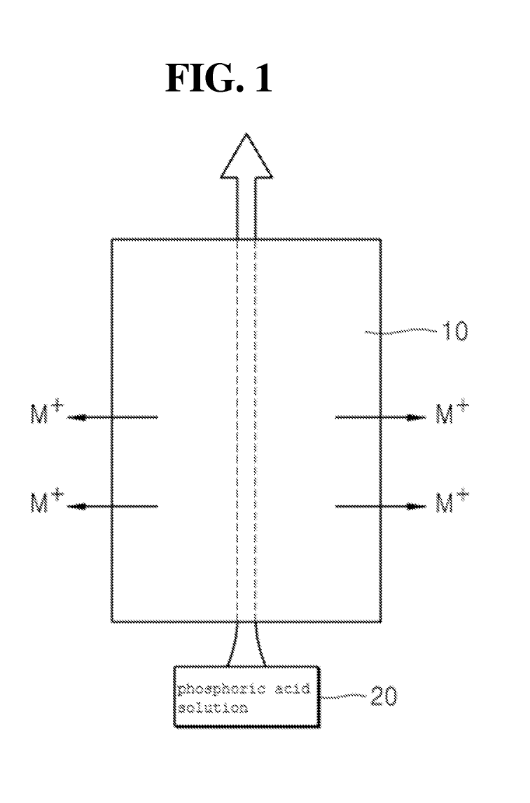

The step of passing the phosphoric acid solution to the washed ion exchange resin is as shown in FIG. 1.

As shown in FIG. 1, in accordance with the present invention, the metal ion (M+) contained in the phosphoric acid solution is purified by passing a phosphoric acid solution (20) to the washed ion-exchange resin (10) in an up-flow direction. The phosphoric acid to be purified by removing impurities is passed to the ion-exchange resin at a temperature condition of 10 to 60° C., and more preferably 20 to 40° C.

If the temperature condition deviates from the above range, the purification efficiency may be lowered. Phosphoric acid is an acid having a high viscosity. Therefore, if the temperature is lower than the above range, the viscosity becomes higher and the flow in the ion-exchange resin tower becomes difficult and so the pressure in the resin tower is increased and also the contact efficiency between the ion-exchange resins is lowered. Also, if the temperature is too high, the ion exchange resin may be decomposed due to surpassing the heat resistance of the ion exchange resin. Further, a phenomenon of eluting the impurities in the ion exchange resin can occur. If the temperature condition deviates from the upper limit and the lower limit of the above range, it may cause a reduction in the purification efficiency. Therefore, it is important to maintain the proper temperature.

Also, it is preferred that, during the liquid passing, the linear velocity is 0.5˜16.0 M/H and the space velocity is 0.8 to 26.0/H. It is more preferred that the linear velocity is 0.5 to 6.0 M/H and the space velocity is 0.8 to 12.6/H. If the linear velocity and the space velocity deviate from the above range, the purification may not sufficiently performed due to too fast flow rates, or if the flow rates become overly slow, there may be a danger of dissolution and this may cause a reduction in productivity.

The phosphoric acid solution is passed to an ion exchange resin and then the phosphoric acid solution may be passed incidentally. At this time, as the ion exchange resin, that reproduced through the reproduction process may be used, and a new ion exchange resin installed with the second tower and located within the tower may be used.

Meanwhile, it is important to set the time for passing a phosphoric acid solution to an ion exchange resin, i.e. the contact time of the ion exchange resin and a phosphoric acid solution. Since the binding force between a functional group of the ion exchange resin and a metal ion (impurities) in the phosphoric acid solution is not high, there may occur a phenomenon of eluting the metal impurities present in the ion exchange resin with phosphoric acid when standing for a long time or depending on a batch purification process.

Thus, in accordance with the present invention, phosphoric acid is purified using a continuous resin tower, wherein the purification is carried out by setting the time for passing phosphoric acid solution to an ion exchange resin. Since the method for basically passing impurities through a continuous tower and purifying the impurities is composed of a stationary phase and a mobile phase, this is theoretically similar to chromatography, and the efficiency is determined according to VAN DEEMTER EQUATION of the following formula 1:

H=A+B/U+CU [Formula 1]

wherein H is singular or height(efficiency) of the tower, A is the number of paths in which fluid can flow to avoid the ion exchange resin in a tower, B/U is the amount of impurities which can be eluted in an ion exchange resin, CU is the amount in which the ion-exchange resins and the phosphoric acid are in contact with each other to occur the ion exchange, and U is the velocity of the fluid.

That is, that point at which the total sum H is minimized can indicate the maximum purification efficiency at the optimum moving speed. If the moving speed of the phosphoric acid solution is too slow, it is possible to react for a long time and thus purification efficiency can become higher(CU field), but this is also likely to elute impurities in the ion exchange resin into phosphoric acid (B/U items). Accordingly, it is preferable to set the contact time and then pass so that H in the above Formula 1 can be minimized.

The concentration of phosphoric acid in the phosphoric acid solution purified in accordance with the present invention is 0.1 to 85 wt. %. According to the present invention, the phosphoric acid solution can be purified up to a range with a very strong acidity.

In the present invention, the oxidation number of the metal ion which is present in the phosphoric acid solution and thus must be removed can range from 2 to 7.

In particular, the type of the ion exchange resin selected may be varied depending on the oxidation number of the metal ions present as an impurity. Therefore, if the oxidation number of the metal ions to be removed is high as 3 to 7, particularly 5 to 7, it is not easy for a strong acidic cation exchange resin having sulfonic acid functional groups to exert its performance. It is therefore preferable to select a chelating resin. In many cases, the chelate resin has a functional group containing nitrogen such as a glucamine group, an amino group or an aminodiacetate, and also has, as a terminal group, a free base, a hydrogen ion, a sodium ion, a sulfate ion and the like. That is, unlike the sulfonic acid, a plurality of the substitution positions are present in one functional group and so when the oxidation number of the metal ion is 3-7, the binding force is strong and it is not easy to detach. Therefore, when the oxidation number of the metal ions is high, it is preferable to select a chelating resin

In the method of the invention, the metal ions which are present as an impurity in the phosphoric acid solution and thus must removed can include any one selected from Al, Fe and Sb, particularly Sb.

In the purification process of the present invention as described above, the impurity concentration of Al, Fe or Sb present in the phosphoric acid solution can be reduced to the ppb level, respectively individually.

Hereinafter, the present invention is described in more detail with reference to preferred examples and comparative examples.

### EXAMPLES

### Examples 1 to 4

### 1) Experimental Method

85 wt % of phosphoric acid made by burning raw yellow phosphorus(P4) directly in the combustion furnace was diluted and the experiment was carried out with 25 mass % of phosphoric acid. In this case, the concentration of Sb varies depending on the purity of yellow phosphorus, but the concentration of Sb is about 700˜1000 ppb, and when diluted, about 200˜300 ppb.

10 mass % of the ion exchange resin (Dow-IRC747) wherein the main chain is a polystyrene-divinylbenzene copolymer, the functional group is aminophosphonic and the terminal group is sodium ion, is activated with 10 mass % of EP-S hydrochloric acid (DONGWOO). The activated ion exchange resin is then filled in 40 cm PFA tube with a diameter of ½ inch and washed with ultra-pure water in the up-flow direction for 12 hours (linear velocity: 2.7 M/H). The experiment is carried out while changing the flow rate of the diluted phosphoric acid in the up-flow direction. Each experimental condition is as shown in Table 1 below.

### 2) Experimental Results

Phosphoric acid was collected after the first and second passing to an ion exchange resin. The concentrations of Al, Fe, and Sb were analyzed with ICP-OES (Perkin Elmer Corp. Optima 7300DV), and ICP-MS (Perkin Elmer Corp. DRC2). The results are shown in Table 1 below.

TABLE 1

| | Flow | | | | | | | | | |
|---|---|---|---|---|---|---|---|---|---|---|
| | rate | | | | | | | | | |
| | (linear | | | | | | | | | |
| | velocity/ | Al (ppb) | | | Fe (ppb) | | | Sb (ppb) | | |
| | space | Raw | 1st | 2st | Raw | 1st | 2st | Raw | 2st | 2st |
| | velocity) | material | passing | passing | material | passing | passing | material | passing | passing |
| Ex. 1 | 0.9 m/h | 54 | 24 | 10 | 49 | 8 | 4 | 215 | 49 | 16 |
| | 2.2/h | | | | | | | | | |
| Ex. 2 | 2.8 m/h | | 28 | 15 | | 6 | 5 | | 63. | 42 |
| | 6.9/h | | | | | | | | | |
| Ex. 3 | 4.6 m/h | | 33 | 19 | | 4 | 4 | | 70 | 53 |
| | 11.6/h | | | | | | | | | |
| Ex. 4 | 6.5 m/h | | 40 | 23 | | 3 | 3 | | 78 | 60 |
| | 16.3/h | | | | | | | | | |

### Examples 5 to 7

### 1) Experimental Method

85 mass % of phosphoric acid made by burning raw yellow phosphorus(P4) directly in the combustion furnace was diluted and the experiment was carried out with 35 mass % of phosphoric acid. In this case, the concentration of Sb varies depending on the purity of yellow phosphorus, but the concentration of Sb is about 700˜1000 ppb, and when diluted, about 300˜500 ppb.

10 mass % of the ion exchange resin (Dow-IRC747) wherein the main chain is a polystyrene-divinylbenzene copolymer, the functional group is aminophosphonic and the terminal group is sodium ion, is activated with 10 mass % of EP-S hydrochloric acid (DONGWOO). The activated ion exchange resin is then filled in 40 cm PFA tube with a diameter of ½ inch and washed with ultra-pure water in an upflow direction for 12 hours (linear velocity: 2.7 M/H). The experiment is carried out while changing the flow rate of the diluted phosphoric acid in the upflow direction. Each experimental condition is as shown in Table 2 below.

### 2) Experimental Results

Phosphoric acid was collected after the first and second passing to an ion exchange resin. The concentrations of Al, Fe, and Sb were analyzed with ICP-OES (Perkin Elmer Corp. Optima 7300DV), and ICP-MS (Perkin Elmer Corp. DRC2). The results are shown in Table 2 below.

TABLE 2

| | Flow | | | | | | | | | |
|---|---|---|---|---|---|---|---|---|---|---|
| | rate | | | | | | | | | |
| | (linear | | | | | | | | | |
| | velocity/ | Al (ppb) | | | Fe (ppb) | | | Sb (ppb) | | |
| | space | Raw | 1st | 2st | Raw | 1st | 2st | Raw | 2st | 2st |
| | velocity) | material | passing | passing | material | passing | passing | material | passing | passing |
| Ex. 5 | 0.9 m/h | 80 | 36 | 16 | 67 | 7 | 7 | 285 | 64 | 21 |
| | 2.2/h | | | | | | | | | |
| Ex. 6 | 1.8 m/h | | 40 | 19 | | 8 | 7 | | 102 | 28 |
| | 4.5/h | | | | | | | | | |
| Ex. 7 | 2.8 m/h | | 49 | 27 | | 8 | 7 | | 180 | 49 |
| | 6.9/h | | | | | | | | | |

### Examples 8 and 9

### 1) Experimental Method

To 85 wt % of phosphoric acid made by burning raw yellow phosphorus(P4) directly in the combustion furnace, a small amount of 1000 ppm Sb standard solution was added to increase the concentration of Sb.

In other words, the concentration of impurities Sb can be increased to 700˜1000 ppb level, depending on the purity of the raw yellow phosphorus(P4). Accordingly, to the phosphoric acid prepared at about 700 ppb level, Sb was added to prepare the phosphoric acid with a Sb concentration of 1600 ppb based on 85 mass % of phosphoric acid. The experiments were carried out by diluting the phosphoric acid to 35 mass %.

10 mass % of the ion exchange resin (Dow-IRC747) wherein the main chain is a polystyrene-divinylbenzene copolymer, the functional group is aminophosphonic and the terminal group is sodium ion, is activated with 10 mass % of EP-S hydrochloric acid (DONGWOO). The activated ion exchange resin is then filled in 40 cm PFA tube with a diameter of ½ inch and washed with ultra-pure water in an upflow direction for 12 hours (linear velocity: 2.7 M/H). The experiment is carried out while changing the flow rate of the diluted phosphoric acid in the upflow direction. Each experimental condition is as shown in Table 3 below.

### 2) Experimental Results

Phosphoric acid was collected after the first and second passing to an ion exchange resin. The concentrations of Al, Fe, and Sb were analyzed with ICP-OES (Perkin Elmer Corp. Optima 7300DV), and ICP-MS (Perkin Elmer Corp. DRC2). The results are shown in Table 3 below.

TABLE 3

| | Flow | | | | | | | | | |
|---|---|---|---|---|---|---|---|---|---|---|
| | rate | | | | | | | | | |
| | (linear | | | | | | | | | |
| | velocity/ | Al (ppb) | | | Fe (ppb) | | | Sb (ppb) | | |
| | space | Raw | 1st | 2st | Raw | 1st | 2st | Raw | 2st | 2st |
| | velocity) | material | passing | passing | material | passing | passing | material | passing | passing |
| Ex. 8 | 0.9 m/h | 80 | 51 | 23 | 67 | 7 | 7 | 680 | 157 | 57 |
| | 2.2/h | | | | | | | | | |
| Ex. 9 | 1.8 m/h | | 58 | 27 | | 8 | 7 | | 253 | 70 |
| | 4.5/h | | | | | | | | | |

In reviewing the Examples 8 and 9, even if the Sb concentration is increased, Al, Fe and Sb all have the purification effect. Further, even if the Sb concentration is rapidly increased, it can be purified by less than 100 ppb. However, if the concentration of Sb increases, the purification efficiency appears to somewhat decrease. This shows that, in view of the selectivity between the ion exchange resin and the metal ion, the selectivity become high in the order of Fe>Sb>Al.

### Comparative Examples 1 and 2

### 1) Experimental Method

85 mass % of phosphoric acid made by burning raw yellow phosphorus(P4) directly in the combustion furnace was diluted and the experiment was carried out with 25 mass % of phosphoric acid. In this case, the concentration of Sb varies depending on the purity of yellow phosphorus, but the concentration of Sb is about 700 to 1000 ppb, and when diluted, about 200 to 300 ppb.

10 mass % of the ion exchange resin (Dow-IRC747) wherein the main chain is a polystyrene-divinylbenzene copolymer, the functional group is aminophosphonic and the terminal group is sodium ion, is activated with 10 mass % of EP-S hydrochloric acid (DONGWOO). The activated ion exchange resin is then filled in 40 cm PFA tube with a diameter of ½ inch and washed with ultra-pure water in an upflow direction for 12 hours (linear velocity: 2.7 M/H). The experiment is carried out while changing the flow rate of the diluted phosphoric acid in the upflow direction. Each experimental condition is as shown in Table 4 below.

### 2) Experimental Results

Phosphoric acid was collected after the first and second passing to *79 ion exchange resin. The concentrations of Al, Fe, and Sb were analyzed with ICP-OES (Perkin Elmer Corp. Optima 7300DV), and ICP-MS (Perkin Elmer Corp. DRC2). The results are shown in Table 4 below.

TABLE 4

| | Flow | | | | | | | | | |
|---|---|---|---|---|---|---|---|---|---|---|
| | rate | | | | | | | | | |
| | (linear | | | | | | | | | |
| | velocity/ | Al (ppb) | | | Fe (ppb) | | | Sb (ppb) | | |
| | space | Raw | 1st | 2st | Raw | 1st | 2st | Raw | 2st | 2st |
| | velocity) | material | passing | passing | material | passing | passing | material | passing | passing |
| Com. | 18.5 m/h | 54 | 40 | 33 | 49 | 10 | 8 | 215 | 163 | 124 |
| Ex. 1 | 46.2/h | | | | | | | | | |
| Ex. 2 | 28.1 m/h | | 48 | 42 | | 8 | 6 | | 183 | 160 |
| | 70.3/h | | | | | | | | | |

In reviewing the Comparative Examples 1 and 2, even if the linear velocity/space velocity is high, the purification efficiency of Sb is lowered and the Sb concentration of the passing phosphoric acid is not lowered to 100 or less and the purification efficiency of Al is decreased

### Comparative Examples 3 to 6

### 1) Experimental Method

85 mass % of phosphoric acid made by burning raw yellow phosphorus(P4) directly in the combustion furnace was diluted and the experiment was carried out with 25 mass % of phosphoric acid. In this case, the concentration of Sb varies depending on the purity of yellow phosphorus, but the concentration of Sb is about 700 to 1000 ppb, and when diluted, about 200 to 300 ppb.

10 mass % of the ion exchange resin (Lewatit 1213MD) wherein the main chain is a polystyrene-divinylbenzene copolymer, the functional group is sulfone and the terminal group is hydrogen, is activated with 10 mass % of EP-S hydrochloric acid (DONGWOO). The activated ion exchange resin is then filled in 40 cm PFA tube with a diameter of ½ inch and washed with ultra-pure water in an upflow direction for 12 hours (linear velocity: 2.7 M/H). The experiment is carried out while changing the flow rate of the diluted phosphoric acid in the upflow direction. Each experimental condition is as shown in Table 5 below.

### 2) Experimental Results

Phosphoric acid was collected after the first and second passing to *79 ion exchange resin. The concentrations of Al, Fe, and Sb were analyzed with ICP-OES (Perkin Elmer Corp. Optima 7300DV), and ICP-MS (Perkin Elmer Corp. DRC2). The results are shown in Table 5 below.

TABLE 5

| | | Flow | | | | | | | | | |
|---|---|---|---|---|---|---|---|---|---|---|---|
| | | rate | | | | | | | | | |
| | | (linear | | | | | | | | | |
| | | velocity/ | Al (ppb) | | | Fe (ppb) | | | Sb (ppb) | | |
| | | space | Raw | 1st | 2st | Raw | 1st | 2st | Raw | 2st | 2st |
| | | velocity) | material | passing | passing | material | passing | passing | material | passing | passing |
| Com. | Purolite | 18.5 m/h | 54 | 53 | 52 | 49 | 48 | 46 | 215 | 194 | 188 |
| Ex. 3 | S957 | 46.2/h | | | | | | | | | |
| Com. | Lewatit | | | 48 | 43 | | 45 | 42 | | 189 | 182 |
| Ex. 4 | 1213MD | | | | | | | | | | |
| Com. | Purolite | 0.2 m/h | | 38 | 32 | | 1233 | 1687 | | 127 | 89 |
| Ex. 5 | S957 | 0.6/h | | | | | | | | | |
| Com. | Lewatit | | | 27 | 23 | | 230 | 347 | | 138 | 79 |
| Ex. 6 | 1213MD | | | | | | | | | | |

In the Comparative Example 3-4, the purification efficiency is not high when passing a different kind of the ion exchange resin from the Examples at a fast linear velocity. In the Comparative Examples 5 and 6, if the flow rate is lowered, it is possible to purify Al and Sb, but in the case of Fe, the concentration is further increased and it is rather contaminated.

When the flow rate is lowered, a sufficient reaction time is given between the ion exchange resin and phosphoric acid, but the possibility of elution conversely becomes very high. As a result, when contacted with an ion exchange resin, the phenomenon in which more pollution occurs as compared with the raw material has been confirmed. That is, in the case of phosphoric acid, it is a strong acid and has physical properties similar to a strong acid and a strong base used during pretreatment and regeneration of the ion exchange resin as described above. Further, impurities of phosphoric acid are not adsorbed on the ion exchange resin, vice versa the metal ion impurities remaining in the ion exchange resin is returned to the side of phosphoric acid, and phosphoric acid is further contaminated.

What is claimed is:

1. A method for removing metal ions in the phosphoric acid solution comprising the steps of:
passing an ion exchange resin through the acid solution to activate the ion exchange resin;
filling a resin tower with the activated ion exchange resin and washing it with ultra-pure water; and
passing the phosphoric acid solution to the washed ion exchange resin,
thereby causing each individual concentration of metal ions with an oxidation number of 2 to 7 present in the phosphoric acid solution to be less than 100 ppb.

2. The method for removing metal ions in the phosphoric acid solution according to claim 1 characterized in that the metal ions removed include any one selected from Al, Fe and Sb.

3. The method for removing metal ions in the phosphoric acid solution according to claim 1 characterized in that the ion exchange resin is a cationic ion exchange resin including any one main chain selected from polystyrene, polyacrylic and divinyl benzene.

4. The method for removing metal ions in the phosphoric acid solution according to claim 1 characterized in that the ion exchange resin is a cationic ion exchange resin, including any one main chain selected from polystyrene, polyacrylic and divinyl benzene, including sulfonic acid functional groups, and containing a terminal group including sodium ions or hydrogen ions.

5. The method for removing metal ions in the phosphoric acid solution according to claim 1 characterized in that the ion exchange resin is a chelate resin having any one main chain selected from polystyrenes, polyacrylics and divinyl benzenes.

6. The method for removing metal ions in the phosphoric acid solution according to claim 1 characterized in that the ion exchange resin contain any one main chain selected from polystyrenes, polyacrylics and divinyl benzenes, contain any one functional group selected from the consisting of glutamine, amidoxime, thiol, amino diacetate, aminophosphone, phosphone/sulfone, picolinic amine and polyamine, and include a terminal group including any one selected from free bases, hydrogen ions, sodium ions, and sulfate ions.

7. The method for removing metal ions in the phosphoric acid solution according to claim 1 characterized in that the ion exchange resin has a crosslinking degree of 5%˜15%.

8. The method for removing metal ions in the phosphoric acid solution according to claim 1 characterized in that the acid solution for the activation of the ion exchange resin is hydrochloric acid.

9. The method for removing metal ions in the phosphoric acid solution according to claim 1 characterized in that the acid solution for the activation of the ion exchange resin is hydrochloric acid having the metal ion concentration of less than 10 ppb based on 35 mass % of hydrochloric acid is diluted in ultra-pure water at a ratio of hydrochloric acid 1:ultra-pure water 3.5 through hydrochloric acid 1:ultra-pure water 12.

10. The method for removing metal ions in the phosphoric acid solution according to claim 1 characterized in that, in the step of passing the phosphoric acid solution to the washed ion exchange resin, the temperature condition is 10 to 60° C.

11. The method for removing metal ions in the phosphoric acid solution according to claim 1 characterized in that, in the step of passing the phosphoric acid solution to the washed ion exchange resin, the linear velocity is 0.5˜16.0 M/H.

12. The method for removing metal ions in the phosphoric acid solution according to claim 1 characterized in that, in the step of passing the phosphoric acid solution to the washed ion exchange resin, the space velocity is 0.8 to 26.0/H.

13. The method for removing metal ions in the phosphoric acid solution according to claim 1 characterized in that the concentration of phosphoric acid in the phosphoric acid solution is 0.1 to 85 mass %.
